(19) United States
(12) Patent Application Publication
(10) Pub. No.: US 2021/0099788 A1
(43) Pub. Date: Apr. 1, 2021

(54) ENERGY ABSORBING EARCUP APPARATUS AND METHOD OF MAKING SAME

(71) Applicant: Airborne Tactical Solutions LLC, Mooresville, NC (US)

(72) Inventor: William M. Challancin, Mooresville, NC (US)

(21) Appl. No.: 17/038,605

(22) Filed: Sep. 30, 2020

Related U.S. Application Data
(60) Provisional application No. 62/907,796, filed on Sep. 30, 2019.

(51) Int. Cl. H04R 1/10; H04R 1/08; G10K 11/178; B64D 11/00

(52) U.S. Cl. CPC H04R 1/1083; H04R 1/1008; H04R 1/08; G10K 11/17873; H04R 1/1075; G10K 2210/3224; H04R 2460/01; H04R 2460/11; H04R 2420/07; G10K 2210/1081; G10K 2210/3011; B64D 11/0015

(57) ABSTRACT

An energy absorbing earcup apparatus for use in an aviation helmet and a method of making same is disclosed. The apparatus can include an earcup body adapted for positioning on a human ear and containing a speaker adapted to emit sound, and a noise attenuating cushioning member surrounding the earcup body. The apparatus can provide active noise reduction. A vent a vent can be formed in the earcup body to provide ventilation for the speaker, and an opening can be formed in the cushioning member that is in communication with the vent.

### CROSS REFERENCE TO RELATED APPLICATIONS

This application claims priority to U.S. Provisional Patent Application No. 62/907,796, filed Sep. 30, 2019.

### TECHNICAL FIELD

The present invention relates to protective equipment for aviators. An embodiment of the invention comprises a protective earcup assembly for use in helicopter and/or fixed-wing aircraft aircrew helmets.

### BACKGROUND

Generally, helmets for military helicopter pilots and other aircrew must pass a variety of tests and standards required by the United States government. One of the most difficult tests to pass in the stated requirements specification is the side impact (SI) crash attenuation test. This test consists of measuring the impact forces in the earcup area of the helmet using specific test specifications and conditions.

### SUMMARY

One object of the present invention is to provide an energy absorbing earcup assembly that can be used in aviation aircrew helmets that provides improved side impact attenuation. Another object of the present invention is to provide an energy absorbing earcup assembly that provides improved wearer comfort and noise attenuation. Another object of the invention is to provide an earcup assembly that provides improved passive and/or active noise attenuation. Yet another object of the invention is to reduce assembly weight. Another object of the invention is to provide an earcup assembly that can be easily maintained and/or replaced in the field. These and other objects of the invention can be achieved in various embodiments of the invention disclosed herein.

One embodiment of the invention comprises an energy absorbing ear assembly that utilizes a hybrid approach with a combination of materials that maximize impact, noise and comfort performance.

According to an embodiment of the invention, the energy absorbing ear assembly can incorporate Active Noise Reduction Technology (ANR).

Another embodiment of the invention comprises an aviation helmet comprising the energy absorbing ear assembly.

Another embodiment of the invention comprises a method wherein the energy absorbing ear assembly is used in an aviation helmet.

Another embodiment of the invention comprises a method of making an energy absorbing ear assembly adapted for use with an aviation helmet.

According to an embodiment of the invention, a conventional aviation headset is used in making an energy absorbing ear assembly adapted for use with an aviation helmet.

An embodiment of the invention comprises an energy absorbing earcup apparatus for use in an aviation helmet comprising a foam housing having a front side and a back side opposite the front side, a speaker adapted to emit sound positioned within an opening formed in the front side of the housing, and a noise attenuating backing member attached to the back side of the housing.

According to an embodiment of the invention, the apparatus provides active noise reduction. The speaker can include an electroacoustic transducer operatively connected to an active noise reduction circuit.

According to an embodiment of the invention, the housing is made of a closed cell foam material.

According to an embodiment of the invention, the housing is comprised of polyethylene, polyurethane, neoprene, ethylene propylene diene monomer rubber, and/or polyvinyl chloride and nitrile-butadiene rubber.

According to an embodiment of the invention, a seal member can be positioned over the speaker.

According to an embodiment of the invention, a fabric covering can be positioned over the housing.

According to an embodiment of the invention, the backing member is made of plastic.

Another embodiment of the invention comprises an energy absorbing earcup apparatus for use in an aviation helmet. The apparatus comprises an earcup body adapted for positioning on a human ear and containing a speaker adapted to emit sound, and a noise attenuating cushioning member surrounding the earcup body.

According to an embodiment of the invention, the apparatus provides active noise reduction.

According to an embodiment of the invention, the speaker comprises an electroacoustic transducer operatively connected to an active noise reduction circuit,

According to an embodiment of the invention, the apparatus comprises an active noise reduction microphone positioned in the cushioning member.

According to an embodiment of the invention, the cushioning member comprises a closed cell foam.

According to an embodiment of the invention, the cushioning member can be comprised of polyethylene, polyurethane, neoprene, ethylene propylene diene monomer rubber, and/or polyvinyl chloride and nitrile-butadiene rubber.

According to an embodiment of the invention, a vent is formed in the earcup body, and provides ventilation for the speaker.

According to an embodiment of the invention, an opening is formed in the cushioning member in communication with the vent in the earcup body.

According to an embodiment of the invention, an attachment member can be positioned on the cushioning member. The attachment member can facilitate attachment of the apparatus to an aviation helmet.

According to an embodiment of the invention, the attachment member can comprise a plurality of hook fasteners. According to another embodiment of the invention, the attachment member can comprise a plurality of loop fasteners.

Another embodiment of the invention comprises a method of making an aviation helmet.

Another embodiment of the invention comprises adapting a conventional aviation headset for use in an aviation helmet.

Another embodiment of the invention comprises an aviation helmet comprising an energy absorbing earcup assembly.

An embodiment of the invention comprises an aviation helmet apparatus comprises a helmet having an interior surface that contacts the user's head when the user is wearing the helmet. An energy absorbing earcup apparatus can be releasably attached to the interior surface of the helmet. The earcup apparatus comprises a earcup body containing a speaker adapted to provide active noise reduction, a noise attenuating foam member surrounding the earcup body, and a first attachment member positioned on the cushioning member. A second attachment member can be positioned on the interior surface of the helmet adapted for complementary releasable engagement with the first attachment member, the first attachment member engaged to the second attachment member whereby the earcup apparatus is releasably attached to the helmet.

According to an embodiment of the invention, a plurality of hook fasteners are positioned on the foam member, and plurality of loop fasteners are positioned on the interior surface of the helmet. According to another embodiment of the invention, a plurality of loop fasteners are positioned on the foam member, and plurality of hook fasteners are positioned on the interior surface of the helmet.

According to an embodiment of the invention, a vent is formed in the earcup body to provide ventilation for the speaker, and an opening is formed in the foam member that is aligned with the vent and in communication with the vent.

### BRIEF DESCRIPTION OF THE DRAWINGS

FIG. 1 is a perspective view of an earcup apparatus according to an embodiment of the invention;

FIG. 2 is an exploded perspective view of the apparatus of FIG. 1;

FIG. 3 is a front view of the apparatus of FIG. 1;

FIG. 4 is a rear view of the apparatus of FIG. 1;

FIG. 5 is an exploded view of the apparatus of FIG. 1;

FIG. 6 is another exploded view of the apparatus of FIG. 1;

FIG. 7 is another exploded view of the apparatus of FIG. 1;

FIG. 8 is a partial perspective view of the apparatus of FIG. 1;

FIG. 9 is another exploded view of the apparatus of FIG. 1;

FIG. 10 is another perspective view of the apparatus of FIG. 1;

FIG. 11 is a perspective view of an earcup apparatus according to another embodiment of the invention;

FIG. 12 is a front elevation of an earcup assembly of the earcup apparatus of FIG. 11;

FIG. 13 is another perspective view of the apparatus of FIG. 11;

FIG. 14 is a partial perspective view of the apparatus of FIG. 11;

FIG. 15 is a partial exploded view of an earcup assembly of the earcup apparatus of FIG. 11;

FIG. 16 is a side view of an earcup assembly of the earcup apparatus of FIG. 11;

FIG. 17 is a perspective view of an aviation headset that can be used in a method of making the earcup apparatus of FIG. 11;

FIG. 18 is a perspective view of an aviation helmet according to an embodiment of the invention; and

FIG. 19 is another perspective view of the aviation helmet of FIG. 18.

### DETAILED DESCRIPTION OF PREFERRED EMBODIMENTS

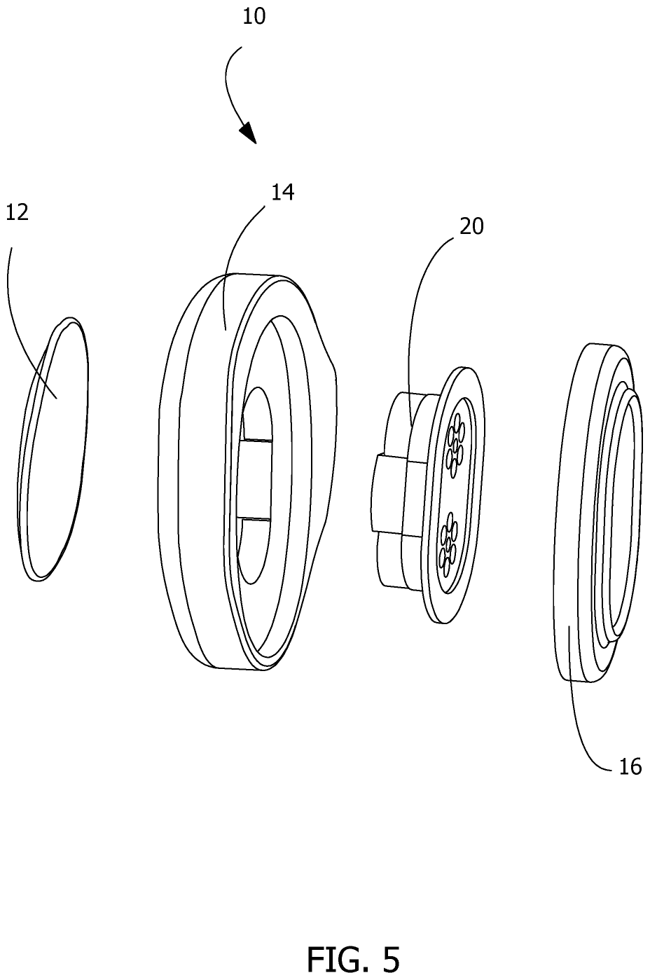

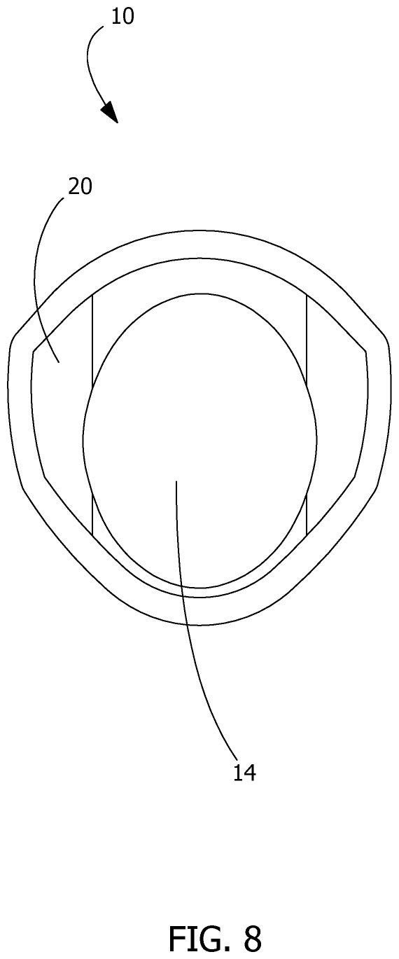

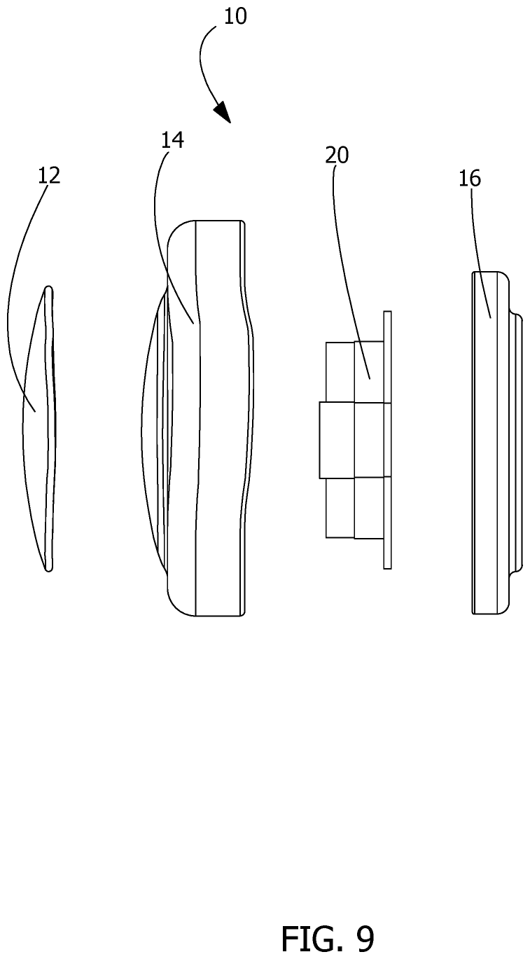

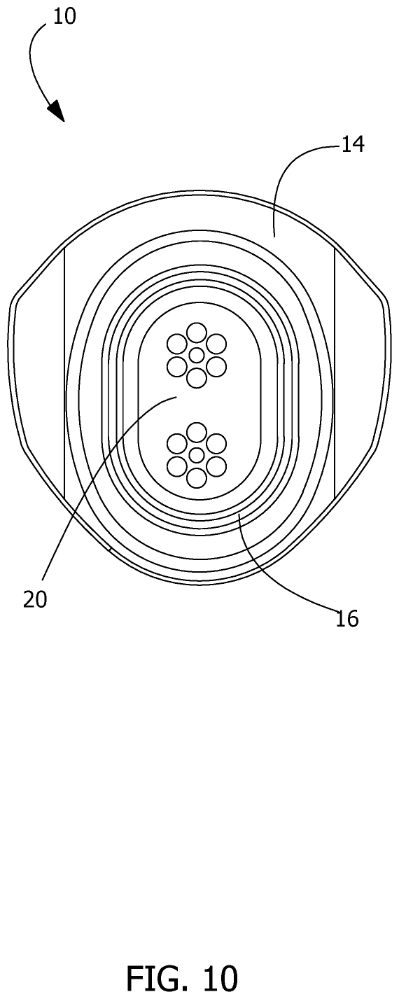

An energy absorbing earcup apparatus according to a preferred embodiment of the invention is illustrated in FIGS. 1-10 and shown generally at reference numeral 10. As shown in FIGS. 1-10, the apparatus 10 comprises a noise attenuating backing member 12 that is attached to an impact and noise attenuating housing 14. The backing 12 can be made of plastic or other suitable material. The housing 14 can be made of foam, such as polyurethane, or other suitable material. The backing 12 can be bonded to the housing 14.

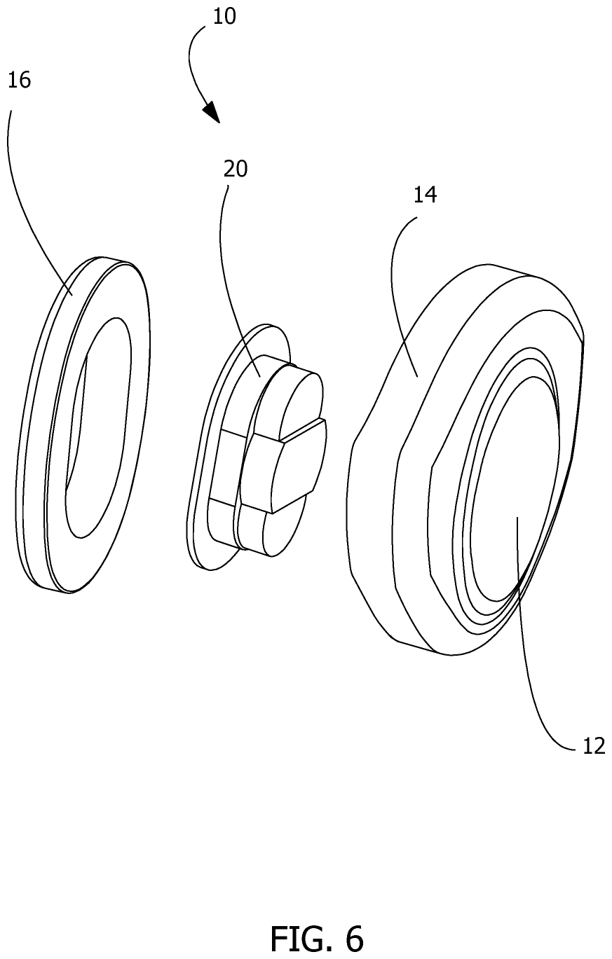

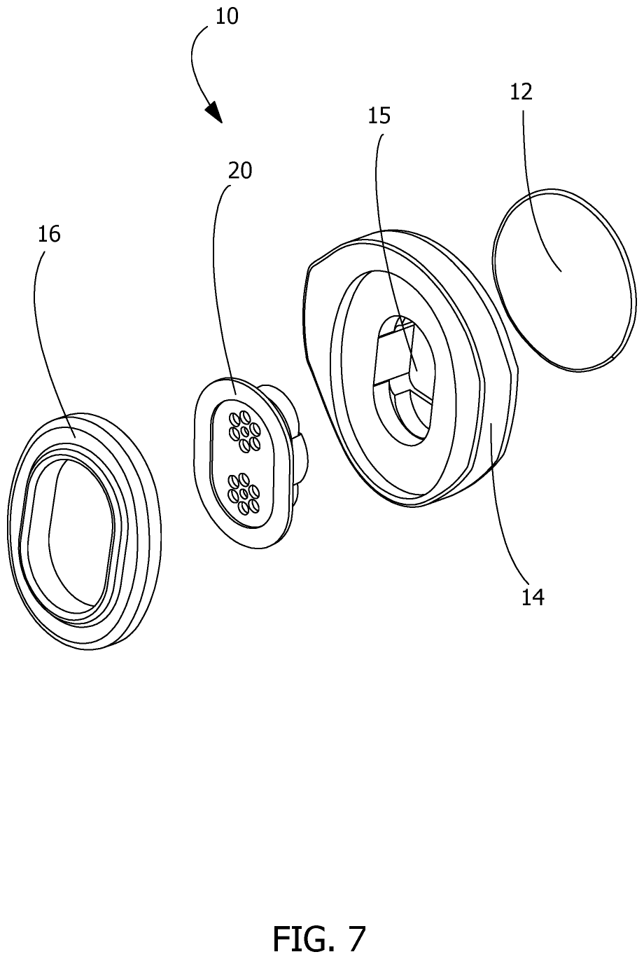

The apparatus 10 can include a speaker 20 positioned within an opening 15 in the foam housing 14, as shown in FIGS. 5 and 6. The speaker 20 can be passive or active. The speaker 20 can include Active Noise Reduction technology (ANR).

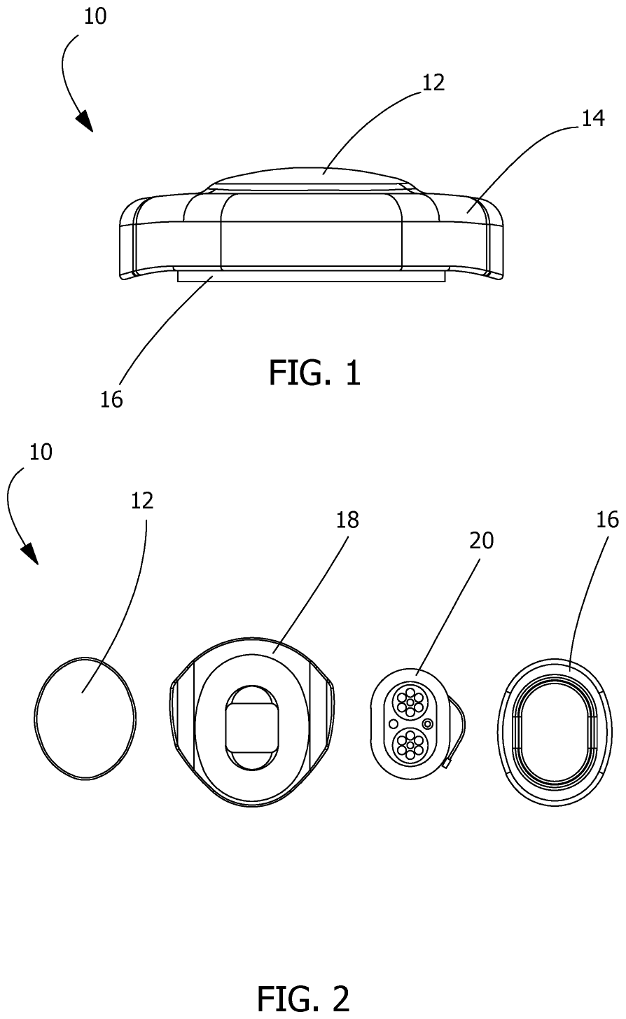

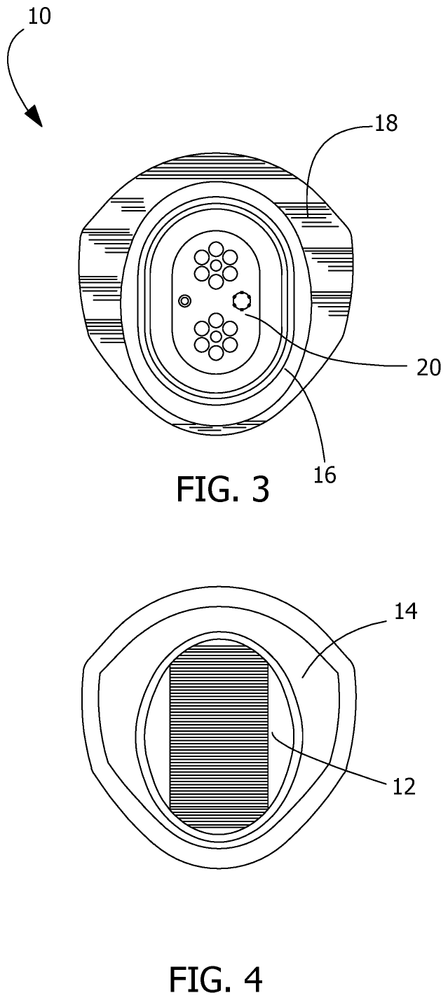

An ear seal member 16 is positioned over the speaker 20 and attached to the housing 14, as shown in FIG. 6. A fabric covering 18 can be positioned over the housing 14, as shown in FIG. 2. By incorporating the impact and noise attenuating foam housing 14, the apparatus 10 reduces the amount of hard plastic typically present in known aviation earcups that transmit impact loads through a hard plastic cup positioned towards the wearers head.

In a method of using the apparatus 10 according to a preferred embodiment of the invention, the earcup assembly 10 is used in a helicopter and/or fixed-wing aircrew helmet. The earcup assembly 10 can be used in military, government and/or civilian helicopters and fixed-wing aircraft. Another embodiment of the invention comprises a helmet, such as a helicopter or fixed-wing aircrew helmet, comprising the apparatus 10.

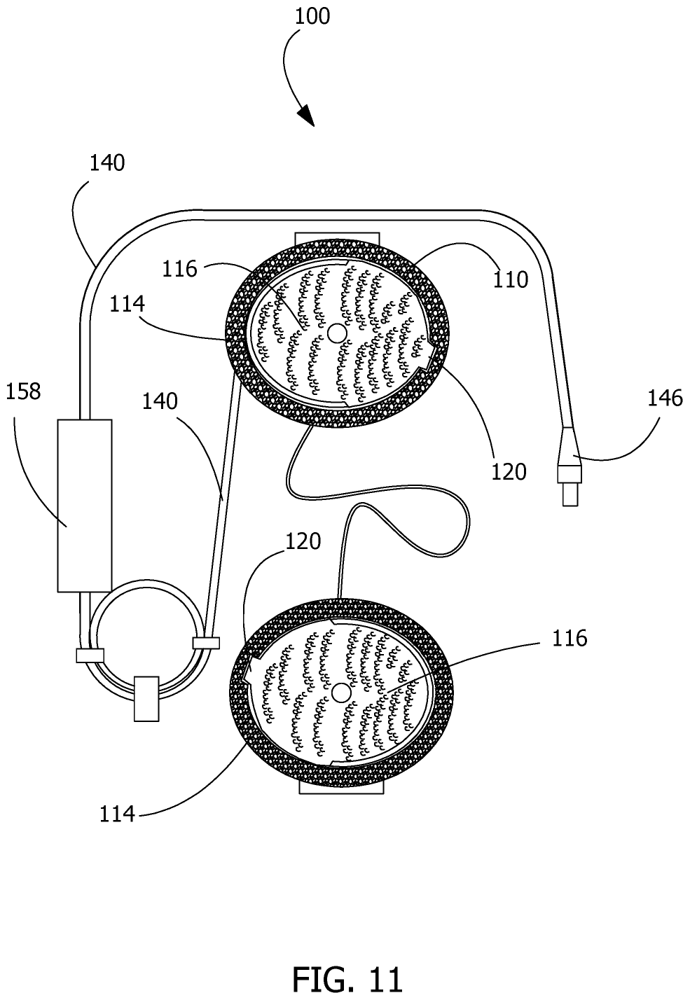

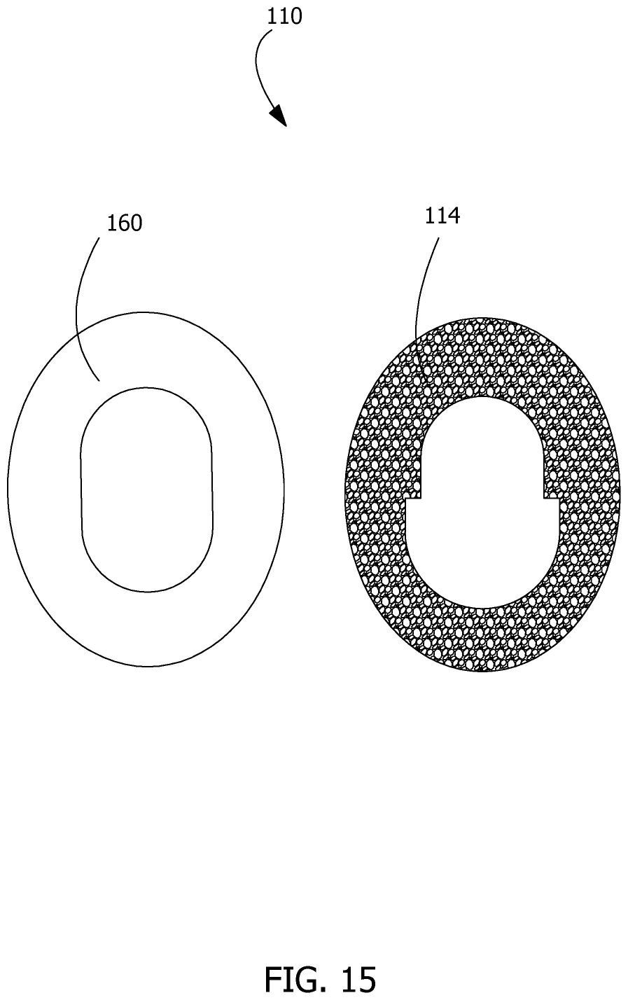

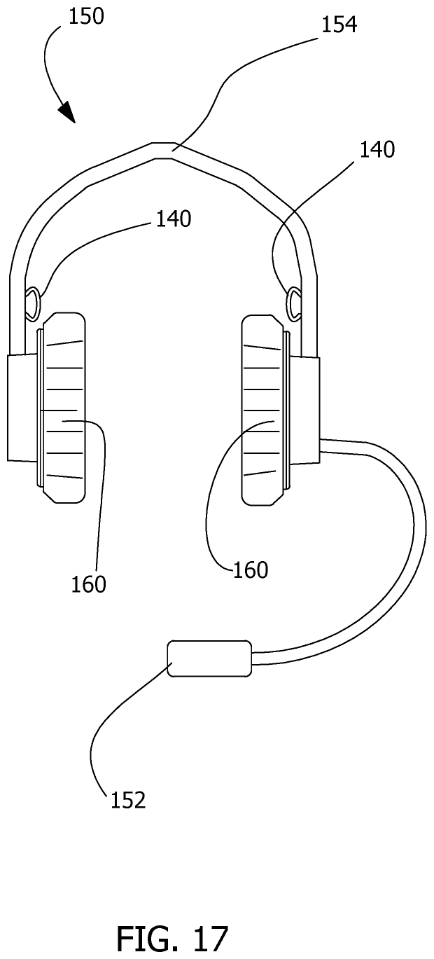

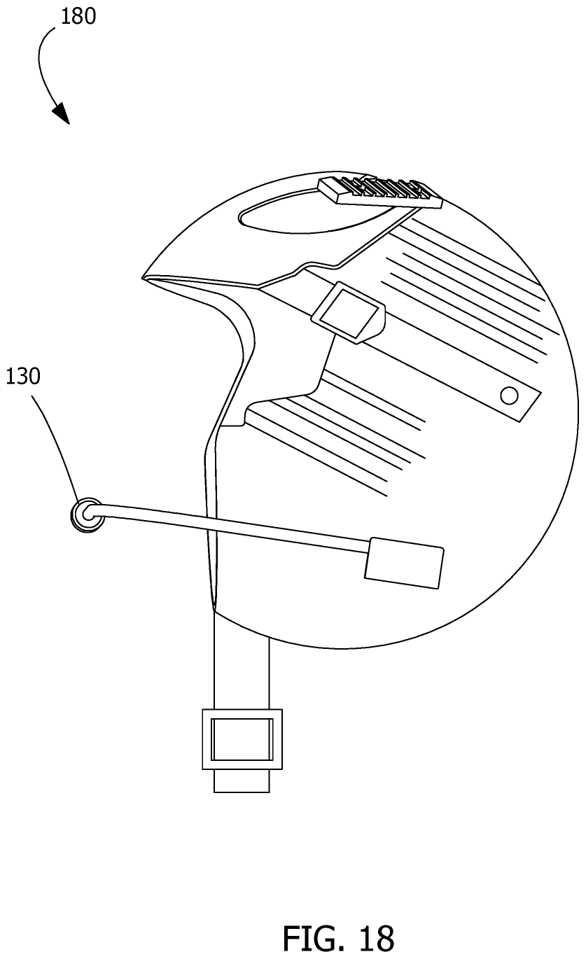

An earcup apparatus according to another preferred embodiment of the invention is illustrated in FIGS. 11-17 and shown generally at reference numeral 100. The earcup apparatus 100 comprises a pair of earcup assemblies 110 comprising cushioning members 114 and is adapted for use with an aviation helmet.

According to an embodiment of the invention, the earcup apparatus 100 can be made using a conventional aviation headset. According to the method, a conventional aviation headset 150, such as the communication headset sold by Bose Corporation as the “BOSE A20 Aviation Headset” is provided. U.S. Pat. No. 8,675,885 is incorporated herein by reference. The headset 150 has an Active Noise Reduction (ANR) circuit and includes wireless communication technology (Bluetooth), volume control, and cell phone integration. The headset 150 is dissembled to remove the boom microphone 152 and the over the head headband 154, leaving Left and Right earcups 160 connected by the crossover cable 140 of the headset 150.

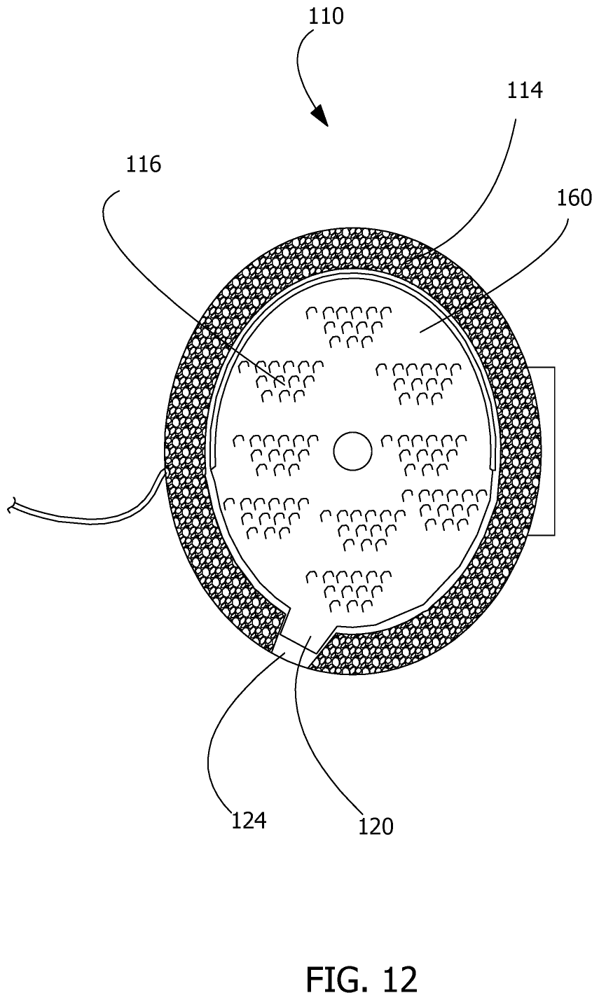

An additional air vent 120 is formed in the lower portion of each earcup 160, as shown in FIG. 12. The air vent 120 allows free flow of air to the driver/speaker. The vents 120 can be formed by machining away part of the outer cover of each earcup 160. The vents 120 allow air flow to the driver/speaker of each earcup 160. Each vent 120 can be about ¼ inch by 1/32 inch in size. The original vents 162 of the earcups 160 can be left exposed to aid in venting. The original boom microphone 152 is removed.

The cushioning members 114 comprise surrounds that can be precision machined or injection molded and are made of a cushioning material. The cushioning surrounds 114 are shaped and sized to receive and conform to the earcups 160. The cushioning surrounds 114 are preferably made of an impact absorbing closed cell foam material. The cushioning surrounds 114 can be made of polyethylene foam, polyurethane foam, neoprene, ethylene propylene diene monomer rubber (EPDM), and/or polyvinyl chloride and nitrile-butadiene rubber (PVC/NBR). An opening 124 is formed in each surround 114, as shown in FIG. 12. The opening 124 provides air flow clearance for the vent 120. The opening 124 also allows the main communication cable to exit the earcup 160. The cable can be configured to exit from the left or right earcup 160 but is only present on one side or the other.

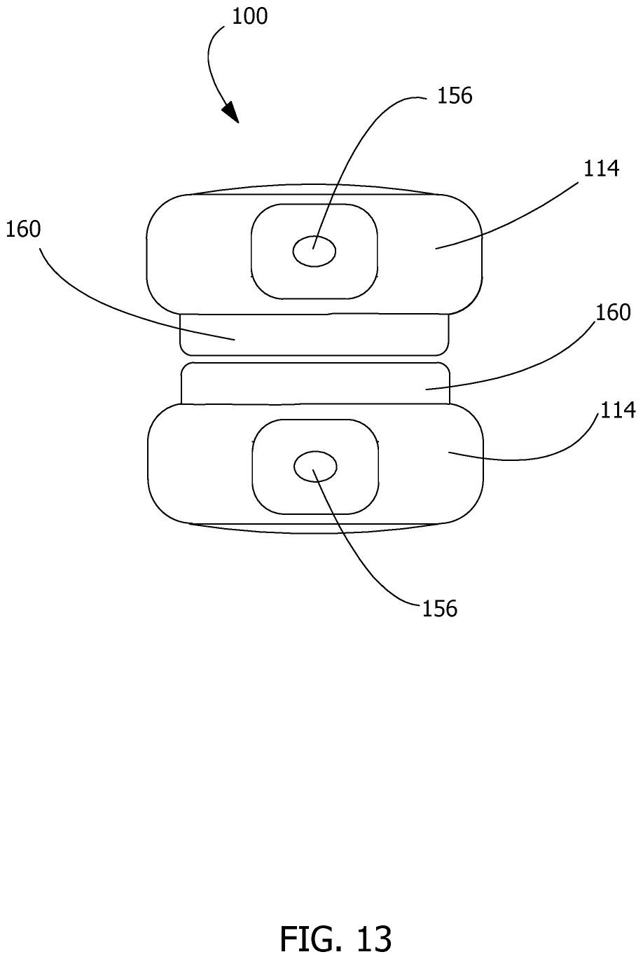

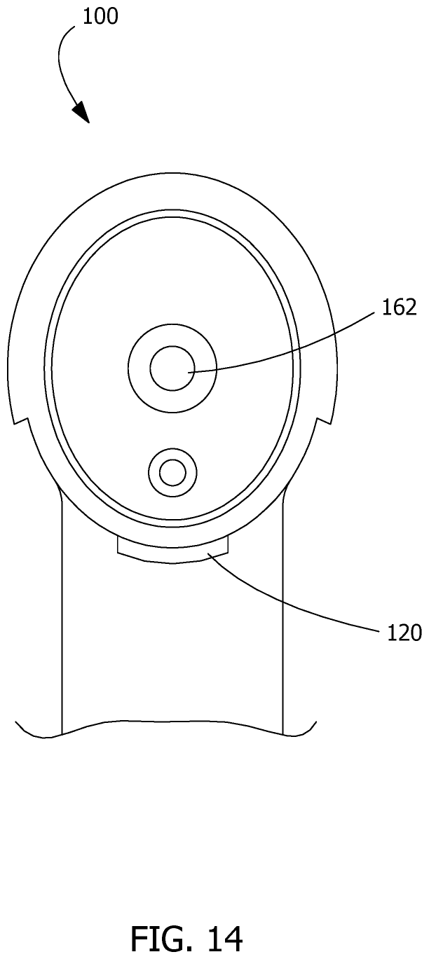

The ANR microphone 156 is removed from each earcup 160 and the wiring harness is extended to allow relocation and integration into each surround 120. The wiring from the ANR microphone 156 can be positioned through the opening 124 of either surround 120, and the ANR microphone 156 can be positioned in the front of the foam surround 124, as shown in FIG. 13. The ANR microphone 156 senses ambient cockpit/environmental noise levels and wavelength so that the Active Noise Reduction circuitry can generate “anti-noise” to cancel it out.

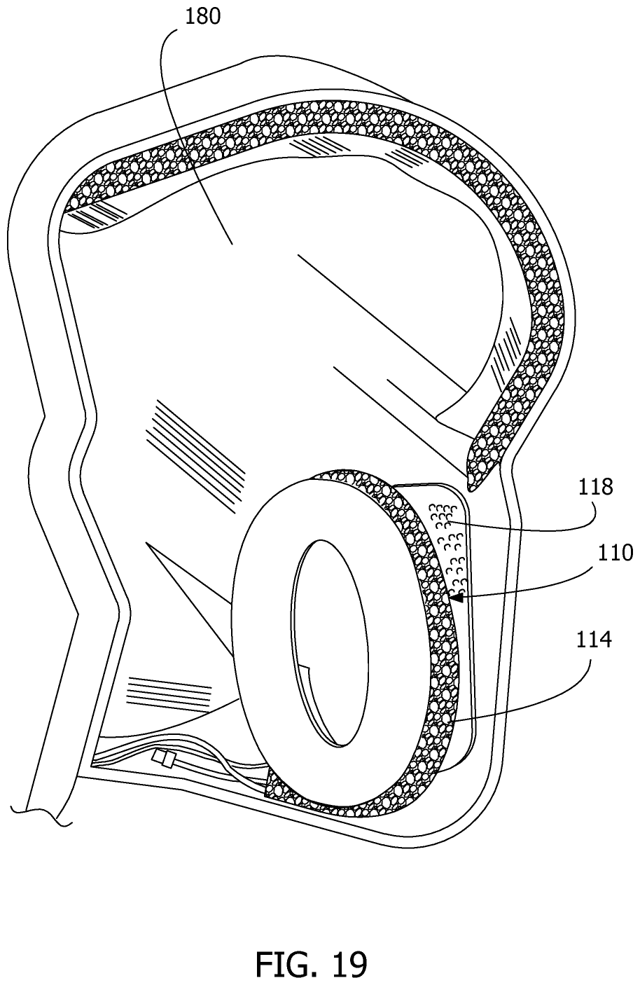

A layer of Velcro fasteners 116 is applied to the outer surface of each earcup 160. The Velcro fasteners 116 allow direct attachment to the inside of the aviation helmet 180, as shown in FIG. 19. The Velcro fasteners 116 can be a plurality of hook fasteners 116 that mate with loop fasteners 118 positioned on the inside of an aviation helmet 180.

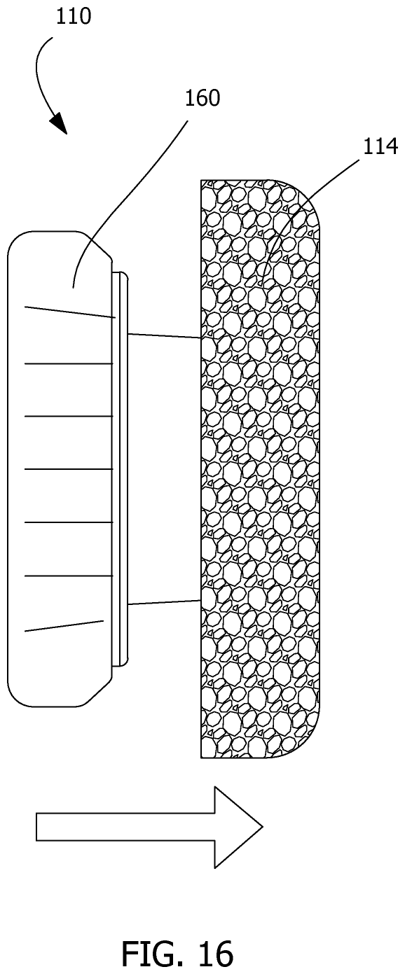

Each earcup 160 is positioned into one of the foam surrounds 120, as shown in FIG. 16, to form earcup assemblies 110. An adhesive material can be used to adhere the earcup 160 to the foam surround 120. The foam surround 120 provides passive noise attenuation and crash impact attenuation.

The battery pack/control module 158 of the headset 150 is removed from the headset 150 and reattached to the earcup assemblies 110. The battery pack/control module 158 provides an electrical interface for the earcups 160. A modified main cable 148 connects the earcup assemblies 110 to the aircraft intercommunication system via plug 146. A voice communication microphone 130 can be mounted to the aircraft helmet 180 and connected to the earcup assemblies 110 via the battery pack/control module 158 and cable 140.

The earcup apparatus 100 can be attached to the interior of the helmet 180 by engaging the hook fasteners 116 on the earcup assemblies 110 with complementary loop fasteners positioned on the interior of the helmet 180.

An energy absorbing earcup apparatus and methods of making and using same are described above. Various changes can be made to the invention without departing from its scope. The above description of preferred embodiments and best mode of the invention are provided for the purpose of illustration only and not limitation.

What is claimed is:

1. An energy absorbing earcup apparatus for use in an aviation helmet comprising:
(a) a foam housing having a front side and a back side opposite the front side;
(b) a speaker adapted to emit sound positioned within an opening formed in the front side of the housing; and
(c) a noise attenuating backing member attached to the back side of the housing.

2. The apparatus according to claim 1, wherein the speaker comprises an electroacoustic transducer operatively connected to an active noise reduction circuit, and the apparatus provides active noise reduction.

3. The apparatus according to claim 1, wherein the housing comprises a closed cell foam.

4. The apparatus according to claim 1, wherein the housing comprises at least one material selected from the group consisting of polyethylene, polyurethane, neoprene, ethylene propylene diene monomer rubber, and polyvinyl chloride and nitrile-butadiene rubber.

5. The apparatus according to claim 1, further comprising a seal member positioned over the speaker.

6. The apparatus according to claim 1, further comprising a fabric covering positioned over the housing.

7. The apparatus according to claim 1, wherein the backing member is comprised of plastic.

8. An energy absorbing earcup apparatus for use in an aviation helmet comprising:
(a) an earcup body adapted for positioning on a human ear and containing a speaker adapted to emit sound; and
(b) a noise attenuating cushioning member surrounding the earcup body.

9. The apparatus according to claim 8, wherein the apparatus is adapted to provide active noise reduction.

10. The apparatus according to claim 8, wherein the speaker comprises an electroacoustic transducer operatively connected to an active noise reduction circuit,

11. The apparatus according to claim 8, further comprising an active noise reduction microphone positioned in the cushioning member.

12. The apparatus according to claim 8, wherein the cushioning member comprises a closed cell foam.

13. The apparatus according to claim 8, wherein the cushioning member comprises at least one material selected from the group consisting of polyethylene, polyurethane, neoprene, ethylene propylene diene monomer rubber, and polyvinyl chloride and nitrile-butadiene rubber.

14. The apparatus according to claim 8, wherein a vent is formed in the earcup body, wherein the vent provides ventilation for the speaker.

15. The apparatus according to claim 12, wherein an opening is formed in the cushioning member in communication with the vent in the earcup body.

16. The apparatus according to claim 8, further comprising an attachment member positioned on the cushioning member adapted for attaching the apparatus to an aviation helmet.

17. The apparatus according to claim 14, wherein the attachment member comprises a plurality of hook fasteners.

18. An aviation helmet apparatus comprising:
(a) a helmet having an interior surface and an exterior surface, the interior surface contacting a user's head when wearing the helmet;
(b) an energy absorbing earcup apparatus comprising an earcup body containing a speaker adapted to provide active noise reduction, a noise attenuating foam member surrounding the earcup body and a first attachment member positioned on the cushioning member; and
(c) a second attachment member positioned on the interior surface of the helmet adapted for complementary releasable engagement with the first attachment member, the first attachment member engaged to the second attachment member whereby the earcup apparatus is releasably attached to the helmet.

19. The apparatus according to claim 18, wherein the first attachment member comprises a plurality of hook fasteners, and the second attachment member comprises a plurality of loop fasteners.

20. The apparatus according to claim 18, wherein a vent is formed in the earcup body to provide ventilation for the speaker, and an opening is formed in the foam member that is in communication with the vent.
